(19) United States
(12) Patent Application Publication
(10) Pub. No.: US 2009/0278931 A1
(43) Pub. Date: Nov. 12, 2009

(54) VIDEO DATA TRANSMISSION SYSTEM FOR REMOTE-MONITORING AND REMOTE-MONITORING EQUIPMENT USING THE SAME

(75) Inventors: Kyoung-Bum Lee, Seoul (KR); Ho-Jin Rhu, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY, KYEONGGI-DO (KR)

(21) Appl. No.: 12/306,925

(22) PCT Filed: Jun. 30, 2006
(86) PCT No.: PCT/KR06/02577

§ 371 Date: Dec. 29, 2008

(51) Int. Cl. H04N 7/18; H04N 5/38

(52) U.S. Cl. 348/143; 348/723; 348/E07.085; 348/E05.093

(57) ABSTRACT

A video transmitter for remote monitoring includes at least one transmitter and a concentrator. The at least one transmitter is installed in the establishment to be monitored and connected to a predetermined number of surveillance cameras, receives video signals of the surveillance cameras in parallel, and transmits the video signals of the surveillance cameras to the central control center at a predetermined upstream data rate, the transmitter being controlled by control data transmitted by the central control center. The concentrator is installed in the central control center, includes at least two receiving modules for concentrating the video signals transmitted by the respective transmitters, transmits the concentrated video signals to the central control center's manager, receives control data for the transmitters from the central control center's manager, and transmits the control data to the transmitters at a downstream data rate that is equal to or less than the upstream data rate.

### TECHNICAL FIELD

The present invention relates to a video transmitter for remote monitoring, and in particular, it relates to a video transmitter for remote monitoring for transmitting image information and management signals by using a preinstalled telephone line, an optical cable, and a coaxial cable without an additional dedicated cable.

### BACKGROUND ART

In general, a remote monitoring device represents a device for monitoring a remote specific region or building environment through video in an unmanned manner. The conventional representative remote monitoring device includes a closed circuit television (CCTV). The image taken by a CCTV camera is transmitted to a central control center through an additionally installed private network (e.g., a telephone line, an optical cable, or a coaxial cable), and the transmitted image is output to a surveillance monitor provided in the central 20: control center or is stored in a storage device provided therein. Also, the CCTV camera is driven by control instructions transmitted by a controller of the central control center through an additional communication line such as an unshielded twisted pair (UTP).

However, the conventional CCTV camera device incurs large installation and maintenance costs since it requires additional installation of coaxial cables and communication lines. Further, received image quality is deteriorated depending on the cable length when the image is transmitted by using the coaxial cable. For example, the maximum transmission length of the coaxial cable is about 500 m when no repeater is used. Long distance transmission is possible when a repeater is installed, however this further increases the cost of installation and maintenance.

In order to solve the above-noted problem, published Korean Application No. 2001-81961 discloses a remote monitoring system using an asymmetric digital subscriber line modem in the reverse direction. In the remote monitoring system, when the transmission direction from a remote terminal installed in an establishment to be monitored to the central control center is set to be upstream and the reverse direction is set to be downstream, the upward and downward transmission bandwidths of the existing asymmetric digital subscriber line (ADSL) technique is changed with each other so that the bandwidth of the upward bandwidth is wide and that of the downward bandwidth is narrow. FIG. 1 shows a detailed configuration of the system including a first ADSL modem provided to a remote terminal and a second ADSL modem provided to a central office, and the modems transmit data at the upstream data rate of 8 Mbps and at the downstream data rate of 384 Mbps. Accordingly, it is possible for the remote security monitoring device having a large data volume in the upstream bandwidth and a smaller data volume in the downstream bandwidth to perform real-time remote monitoring.

The above-noted device uses the installed telephone line and there is no need to install an additional dedicated line such as a coaxial cable, thereby reducing the cost of installation and maintenance. Also, since it is possible to provide a data rate of 3 Mbps at a distance within 4 km and 1 Mbps at a distance within 5 km without installing a repeater in the case of the ADSL, it is possible to transmit quality images a longer distance than compared to the case of using the coaxial cable.

However, in the device according to the published Korean Application, one first ADSL modem corresponds to one second ADSL modem, and it is required to install the same number of pairs of modems as the number of cameras in the remote terminal and the central control center when installing a plurality of CCTV cameras in an establishment or a region to be monitored. In addition, when the remote terminal is provided far from the central control center, i.e., further than 5 km, it is required to install a repeater in order to acquire good images, thereby increasing the cost of installation and maintenance.

Regarding another solution, published Korean Application No. 2003-1626 discloses a data transmission system and method using an asymmetric transmission method. The system uses the asymmetric transmission method for setting the upstream data rate to be greater than the downstream data rate. FIGS. 2A and 2B show devices of the above-noted published applications. FIG. 2A shows a device for multiplexing data transmitted by a plurality of surveillance cameras by using a multiplexer installed in a remote terminal, and transmitting the multiplexed data to a host computer of the central control center. Data transmission is performed between an xDSL central office (CO) module of each camera installed in a remote terminal using any type of a digital subscriber line (xDSL) and an xDSL customer premises equipment (CPE) module installed in the central control center. FIG. 2B shows a device for installing an xDSL CO module in each surveillance camera, connecting the xDSL CO module and the xDSL CPE module, and thus directly transmitting the data to the central control center from the camera. In this case, the xDSL CPE module functions as a multiplexer since it has a multi-mode digital signal processor (DSP).

However, since the devices multiplex the video signals by using the multiplexer installed in the remote terminal or the central control center, image data rates may be deteriorated when the number of surveillance cameras is increased. Also, in a like manner of the above-noted device of the prior art, since the xDSL is used, quality images can be acquired when a repeater is installed when the distance is greater than 5 km, however, the cost of installation and maintenance is accordingly increased.

Published Korean Application No. 2002-92601 discloses an ADSL-based remote security monitoring device. FIG. 3A shows a transmitter of the device, and FIG. 3B shows a receiver thereof. As shown in FIG. 3A, the transmitter includes: a video compressor for controlling digital image information to be transmittable information by using a known image compressing method and outputting the transmittable information; a communication processor for processing compressed digital image into the asynchronous transfer mode (ATM) data and outputting the ATM data; and an ADSL transceiver unit-central office end (ATU-C unit) for converting the compressed digital image data into ADSL transmission standard based data and transmitting the data to a receiver. Also, as shown in FIG. 3B, the receiver includes: an ADSL terminal unit-central office receive unit (ATU-R unit) for receiving the transmitted data, signal-processing the data according to the ADSL transmission standard, and outputting resultant signals; a communication processor for controlling operation of other units of the receiver, receiving image data from the ATU-R unit, performing an encoding process (e.g., H.222 transmission layer process) on the same according to the MPEG-2 standard, and outputting resultant data; and a video expander for restoring the compressed digital image data into the original image data. The receiver increases the data processing rate since it uses a plurality of ATU-R units arranged in parallel without using a multiplexer.

However, the device delays the data processing rate since the communication processor of the receiver performs an MPEG-2 encoding process. Particularly, when using a communication processor having no floating point operation function in order to reduce costs since a communication processor having a floating point operation function is expensive, the delay of processing rate may be substantially increased. Also, for example, since the device only uses the ADSL transmission method, the device cannot provide quality images from establishments or regions located at a distance of more than 5 km.

### DISCLOSURE

### Technical Problem

The present invention has been made in an effort to provide a remote security monitoring device having advantages of providing quality images from an establishment or a region to be monitored (e.g., located at a distance greater than 5 km) by using the xDSL transmission method and the optical transmission method.

The present invention has been made in another effort to control a concentrator of a central control center to process data transmission and to control an additional device to process image data so as to prevent the data processing rate from being delayed when a network processor having no floating point operation function processes the data that are input through a plurality of channels.

### Technical Solution

In one aspect of the present invention, a video transmitter for remote monitoring for transmitting a video signal output by a surveillance camera installed in an establishment to be monitored to a central control center that is distant from the establishment includes at least one transmitter, and a concentrator. The at least one transmitter is installed in the establishment to be monitored and connected to a predetermined number of surveillance cameras, receives video signals of the surveillance cameras in parallel, and transmits the video signals of the surveillance cameras to the central control center at a predetermined upstream data rate, the transmitter being controlled by control data transmitted by the central control center. The concentrator is installed in the central control center, and includes at least two receiving modules. The at least two receiving modules concentrate the video signals transmitted by the respective transmitters, transmit the concentrated video signals to the central control center's manager, receive control data for the transmitters from the central control center's manager, and transmit the control data to the transmitters at a downstream data rate that is equal to or less than the upstream data rate.

In another aspect of the present invention, a remote security monitoring device for a remote central control center to monitor an establishment to be monitored includes a plurality of surveillance cameras installed at predetermined positions in the establishment to be monitored, at least one transmitter, a concentrator, an image processor for processing the video signals output by the concentrator, and a display for displaying the images processed by the image processor. The at least one transmitter is installed in the establishment to be monitored and connected to a predetermined number of the surveillance cameras, receives video signals of the respective surveillance cameras in a parallel manner, transmits the video signals of the surveillance cameras to a central control center at a predetermined upstream data rate, and starts an operation controlled by control data provided by the central control center. The concentrator is installed in the central control center and includes at least two receiving modules. The at least two receiving modules concentrate the video signals provided by the respective transmitters, transmit the video signals to the central control center's manager, receive control data on the transmitter from the central control center's manager, and transmit the control data to the transmitter at a downstream data rate that is equal to or less than the upstream data rate.

### ADVANTAGEOUS EFFECTS

### DESCRIPTION OF DRAWINGS

FIG. 1 is a brief schematic diagram of a conventional remote surveillance video transmitter.

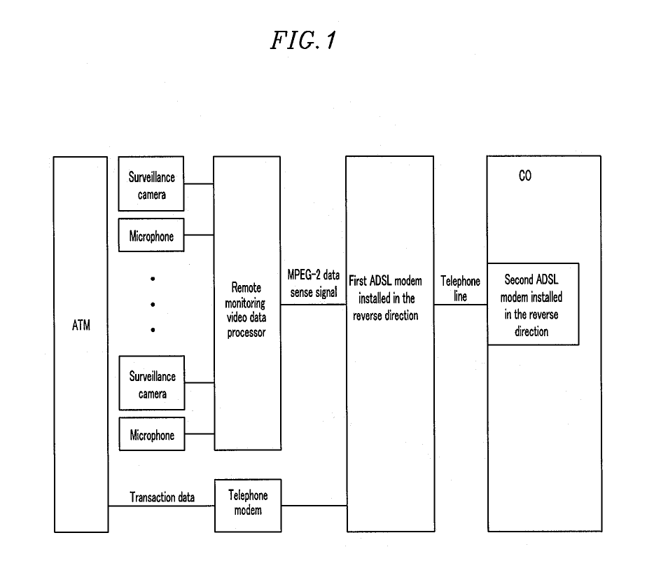

FIG. 2 is a brief schematic diagram of another conventional remote surveillance video transmitter.

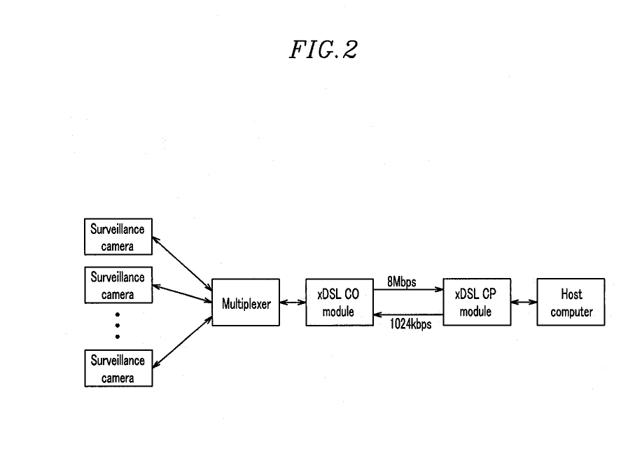

FIG. 3 is a brief schematic diagram for another remote surveillance video transmitter of the prior art shown in FIG. 2.

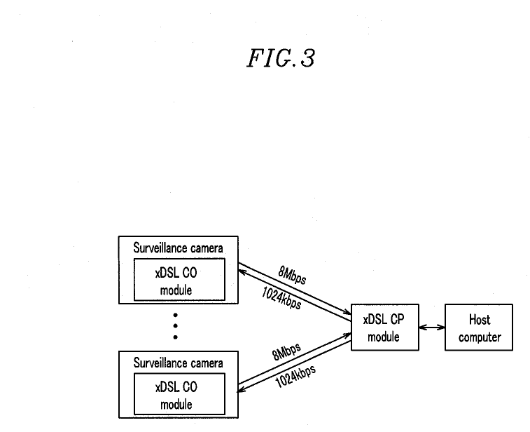

FIG. 4 is a brief diagram for a transmitter of a remote surveillance video transmitter according to another prior art.

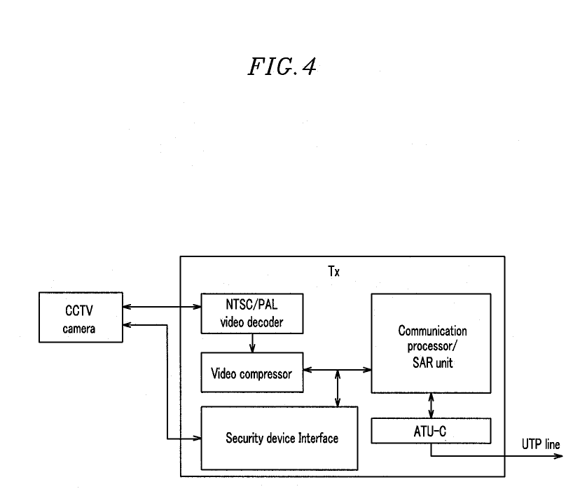

FIG. 5 is a diagram for a receiver of a remote surveillance video transmitter according to the prior art shown in FIG. 4.

FIG. 6 is a schematic diagram for a remote surveillance video transmitter according to an exemplary embodiment of the present invention.

FIG. 7 shows an xDSL transmitter of a remote surveillance video transmitter according to the exemplary embodiment of the present invention shown in FIG. 6.

FIG. 8 shows a concentrator of a remote surveillance video transmitter according to the exemplary embodiment of the present invention shown in FIG. 6.

FIG. 9 shows a remote surveillance video transmitter according to another exemplary embodiment of the present invention.

FIG. 10 shows an optical transmitter of a remote surveillance video transmitter according to the exemplary embodiment of the present invention shown in FIG. 9.

FIG. 11 shows a photodetection module of a remote surveillance video transmitter according to the exemplary embodiment of the present invention shown in FIG. 9.

FIG. 12 shows a remote surveillance video transmitter according to another exemplary embodiment of the present invention.

FIG. 13 shows a cable transmitter of a remote surveillance video transmitter according to the exemplary embodiment of the present invention shown in FIG. 12.

FIG. 14 shows a cable receiving module of a remote surveillance video transmitter according to the exemplary embodiment of the present invention shown in FIG. 12.

### BEST MODE

The objects, features, and advantages of the present invention will be further clarified through the subsequent detailed description provided with reference to the accompanying drawings. Hereinafter, referring to the drawings, a remote surveillance video transmitter according to an embodiment of the present invention will now be described.

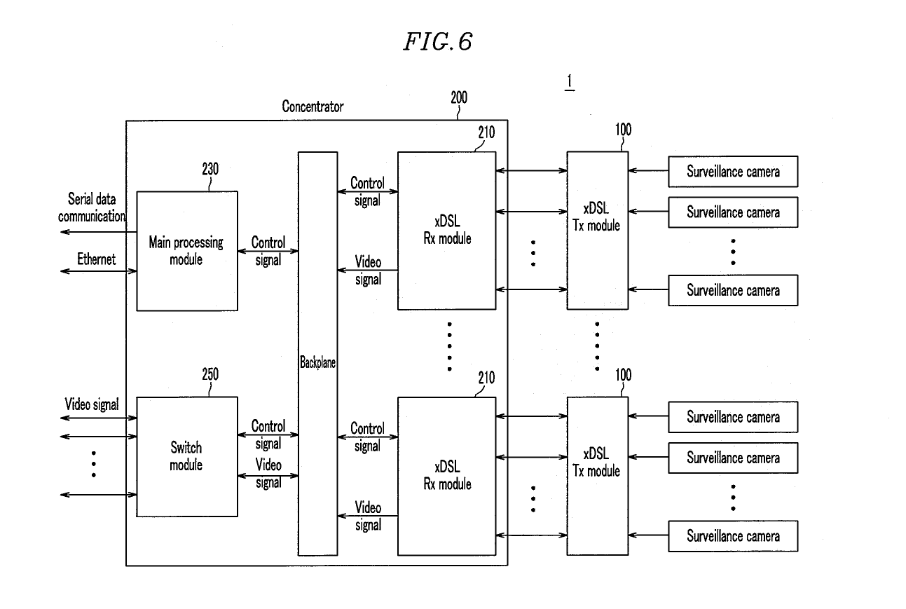

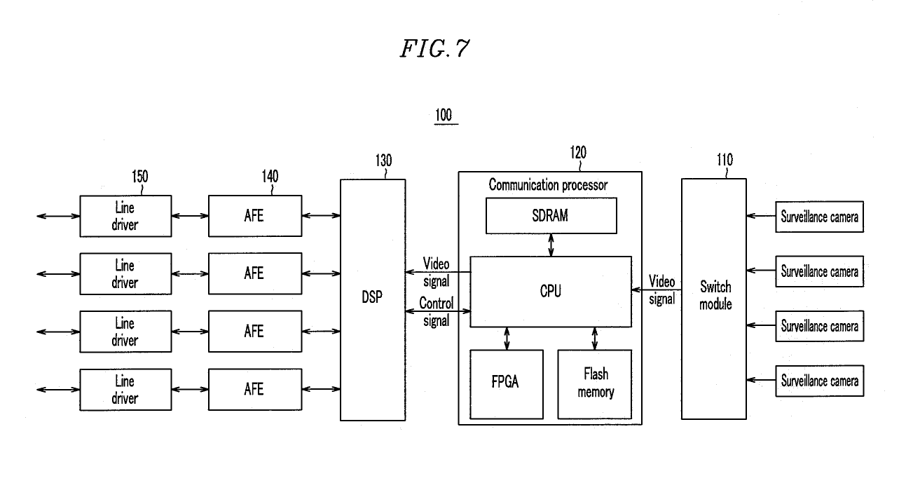

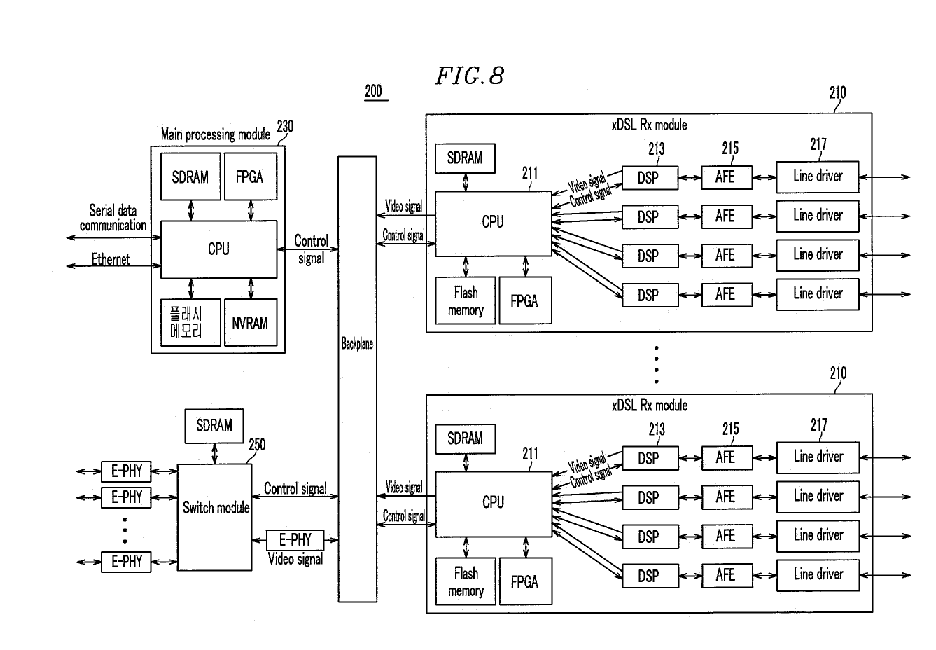

FIG. 6 is a schematic diagram for a remote surveillance video transmitter according to an exemplary embodiment of the present invention, FIG. 7 shows an xDSL transmitter according to the exemplary embodiment of the present invention shown in FIG. 6, and FIG. 8 shows a concentrator according to the exemplary embodiment of the present invention shown in FIG. 6.

As shown in FIG. 6, the remote security monitoring device 1 includes at least one xDSL transmitter 100 installed in an establishment or a region to be monitored and connected to a plurality of surveillance cameras, and a concentrator 200 installed in a central control and concentrating a transmission line from a plurality of xDSL transmitters 100.

Each xDSL transmitter 100 is connected to a plurality of surveillance cameras and transmits video signals input by the surveillance cameras to the concentrator 200 by using the xDSL transmission method. Also, control information on the xDSL transmitter 100 is received through an xDSL transmission based digital data communication, and the operation of the xDSL transmitter 100 is controlled according to the control information.

The concentrator 200 is connected to a plurality of xDSL transmitters 100, receives video signals from the xDSL transmitters 100 through the xDSL transmission method, and outputs resultant signals to a manager. For example, the video signals can be output to an additional image processor. Also, the concentrator 200 transmits information on the respective connected xDSL transmitters 100 to the corresponding xDSL transmitters 100 by using the xDSL transmission method.

For example, in the case of using the ADSL transmission method, the xDSL transmitter 100 transmits the input video signal to the concentrator 200 through the ADSL transmission downstream at the data rate of up to 8 Mbps maximum. Also, the concentrator 200 transmits control in formation on the xDSL transmitter 100 through the ADSL transmission upstream at the data rate of up to 1,024 kbps.

FIG. 7 shows a detailed configuration of the xDSL transmitter 100.

As shown, the xDSL transmitter 100 includes a switch module 110, a communication processor 120, a digital signal processor (DSP) 130, an analog front end (AFE) 140, and a line driver 150. The switch module 110 is connected to a plurality of surveillance cameras and receives video signals. The communication processor 120 controls operations of other units of the xDSL transmitter 100, receives video signals of respective surveillance cameras from the switch module 110, processes the input video signals according to the asynchronous transfer mode (ATM), and outputs resultant signals through a universal test and operation physical interface for ATM (UTOPIA) or an Ethernet bus. The digital signal processor (DSP) 130 performs a framing function for eliminating errors. The analog front end (AFE) 140 converts the xDSL digital data provided by the DSP into analog signals, converts the received analog signals to digital signals, and transmits the digital signals to the DSP. The line driver 150 cancels the noise of transmitted and received signals and compensates signal distortion.

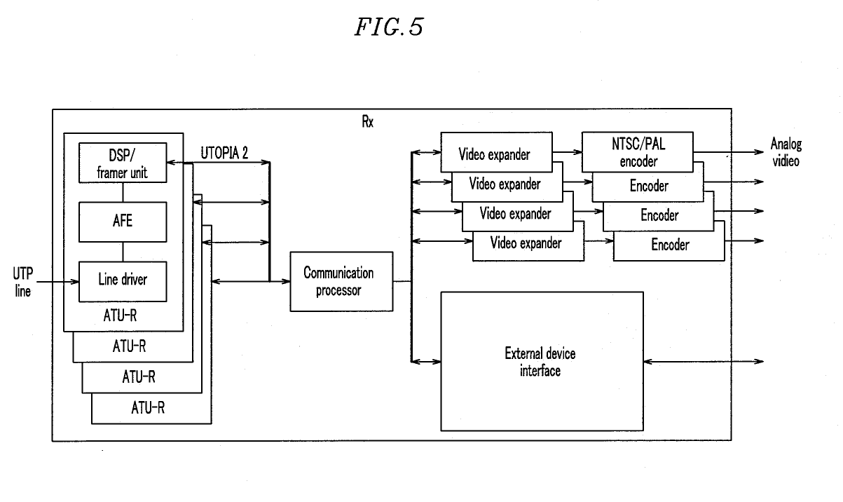

Since a plurality of surveillance cameras are connected to a single xDSL transmitter 100, it is desirable for the DSP 130 to provide the same number of ports as that of the connected surveillance cameras. In the xDSL transmitter 100 shown in FIG. 5, four surveillance cameras are connected and the DSP 130 provides four ports corresponding to the number of the surveillance cameras. However, the number of DSPs 130 is not restricted to 4, and can be varied as needed.

The respective units of the xDSL transmitter 100 will now be described.

The switch module 110 receives video signals from a plurality of surveillance cameras. The surveillance cameras can be selected and used from among any available in the market. Recently, surveillance cameras that have an image compression function and support Ethernet-based communication have been sold. Also, in the case of using an existing CCTV camera, an IP-CODEC for converting the analog video signals into Ethernet video signals is sold, and thereby, Ethernet-based communication is possible by installing the IP-CODEC in the CCTV camera. In the present exemplary embodiment, the above type of camera is used to connect an Ethernet output of the camera to the switch module 110. In the case of using the Ethernet method, quality images can be transmitted at the data rate of 100 Mbps within the distance of 100 m, and so the surveillance camera can be arranged at a place desired by a user irrespective of the installation location of the xDSL transmitter 100. Also, since the surveillance camera compresses the video signal, degradation of the data rate caused by compressing the images by the xDSL transmitter 100 is prevented.

The communication processor 120 controls the switch module 110, the DSP 130, the AFE 140, and the line driver 150. That is, the communication processor 120 processes the video signals input by the switch module 110 according to the ATM rule and transmits resultant signals through the UTOPIA or the Ethernet bus, and analyzes control information transmitted through the concentrator 200 according to a manipulation of an operator in the central control center, converts it into a signal for controlling the xDSL transmitter 100, and outputs the signal. The control signal includes information on a data rate control and a restart of the xDSL transmitter 100. The communication processor 120 includes a communication CPU, a field programmable gate array (FPGA), a flash memory, and a synchronous dynamic random access memory (SDRAM).

The DSP 130, the AFE 140, and the line driver 150 receive digital video signals processed by the communication processor 120, perform xDSL based signal conversion and A/D conversion on the digital video signals, and transmit resultant signals. Also, the same receive control information from the concentrator 200 through the xDSL transmission method, convert the data format, and output resultant data to the communication processor 110. In addition, the DSP 130 eliminates errors from the transmitted data signals.

Although not illustrated in the figure, an xDSL transformer can be provided to the end part of the line driver. The xDSL transformer, including a surge protector circuit having a poly switch and an arrestor, protects the inner circuit from an external surge voltage or lightning.

Although not illustrated in the figure, the xDSL transmitter 100 can include a serial data port connected to the communication processor 120, through which the states of the device are monitored and controlled.

FIG. 8 shows a detailed configuration of the concentrator 200.

As shown, the concentrator 200 includes a plurality of xDSL receiving modules 210 having a plurality of transmission lines and processing transmitted video signals, a main processing module 230 for controlling other units of the concentrator 200 according to the operator's manipulation and outputting a control signal for the xDSL transmitter 100, and a switch module 250 for outputting the transmitted video signal to the outside of the concentrator 200.

The xDSL receiving module 210 includes a communication processor 211, and pluralities of DSPs 213, AFEs 215, and line drivers 217. The line drivers 217 cancel noise from the received video signals and compensate signal distortion, and the AFEs 215 perform A/D conversion on the signals output by the line drivers 217 and output resultant signals to the DSPs 213. The DSPs 213 receive the video signals from the AFEs 215, convert the video signals according to the xDSL transmission standard, and perform framing so as to eliminate errors. The communication processor 211 controls the DSPs 213, the AFEs 215, and the line drivers 217, and processes the ATM video signal according to the internal transmission rule of the concentrator 200. The video signal output by the communication processor 211 is transmitted to the switch module 250 through a backplane of the concentrator 200. The communication processor 211 includes a network processor, an FPGA, a flash memory, and an SDRAM.

Also, the xDSL receiving module 210 receives a control signal on the xDSL receiving module 210 from the main processing module 230 to perform a corresponding operation, receives a control signal on the xDSL transmitter 100, converts the control signal into an xDSL transmission type signal, and transmits a resultant signal to the xDSL transmitter 100.

In the device shown in FIG. 8, four DSPs 213 are connected to each communication processor 211. The communication processor 211 and the plurality of DSPs 213 are connected through the UTOPIA or the Ethernet. In the illustrated xDSL receiving module 210, four DSPs 213 are connected to the communication processor 211, but the number of DSPs are not restricted to four, and a plurality of DSPs (e.g., 8 or 16) can be connected to the communication processor 211.

The main processing module 230 controls each xDSL receiving module 210, the switch module 250, and the remote xDSL transmitter 100. The main processing module 230 includes a main CPU, an FPGA, a flash memory, a non-volatile memory, and an SDRAM. Also, the same can be connected to the outside of a device through a serial data communication method or the Ethernet method.

The switch module 250 outputs the video signals input by a plurality of xDSL receiving modules 210 to the outside of the concentrator 200 by using the Ethernet transmission method. The switch module 250 may include an additional memory for preventing data loss.

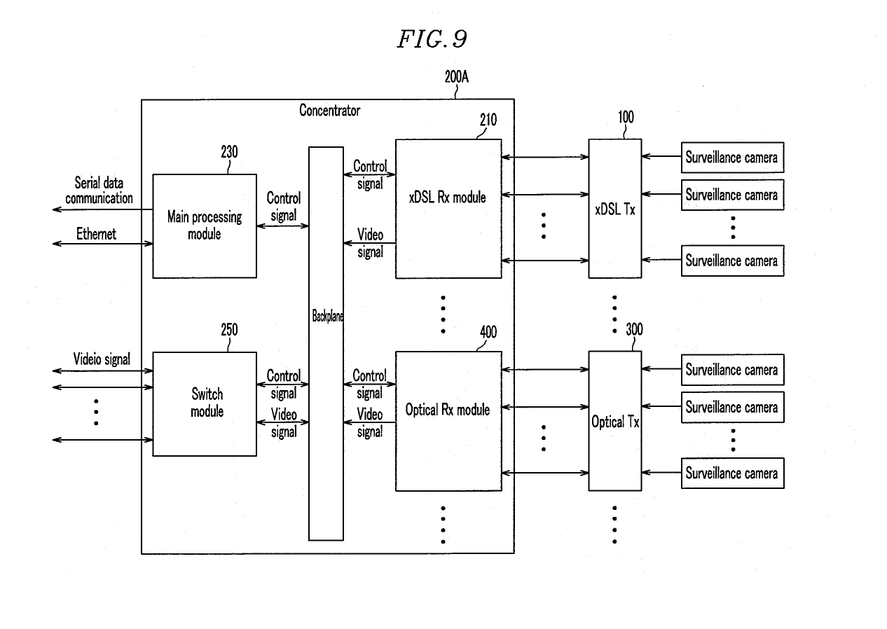

FIG. 9 shows a video transmitter for remote monitoring according to another exemplary embodiment of the present invention. The remote surveillance video transmitter shown in FIG. 9 uses an optical transmission method in addition to the xDSL transmission method. Therefore, the present embodiment has the same configuration as that of the previous embodiment except for further including an optical transmitter 300 for transmitting the video signals of the surveillance camera as optical signals and a photodetection module 400 installed in the concentrator 200. Below, the same modules or units as those given in the previous exemplary embodiment will have the same reference numerals.

As shown in FIG. 9, the video transmitter for remote monitoring according to another exemplary embodiment of the present invention includes an optical transmitter 300 and a photodetection module 400. The optical transmitter 300 is connected to a plurality of surveillance cameras in a like manner as the above-described exemplary embodiment. It is desirable to connect the optical transmitter 300 and the surveillance camera through the Ethernet method. A photodetection module 400 for receiving optical signals from the optical transmitter 300 is provided to the concentrator 200A. It is desirable to connect the photodetection module 400 to a backplane of the concentrator through the same internal transmission method as that of the xDSL receiving module 210 of the previous exemplary embodiment, which means that a receiving module installing slot provided to a main board is not distinguished to be used for the xDSL receiving module and the photodetection module. Hence, when a receiving module is additionally inserted to the slot of the main board so as to extend the facility, there is no need to check the slot type.

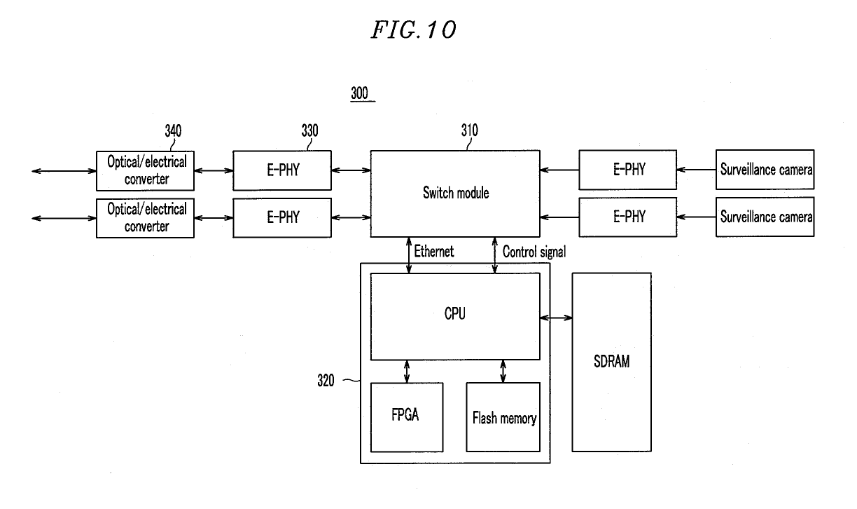

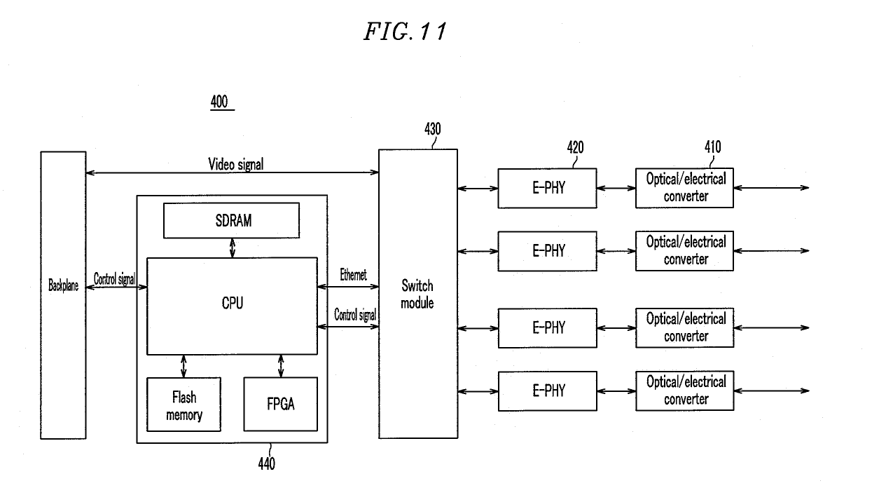

FIG. 10 shows the above optical transmitter 300 according to the present exemplary embodiment of the present invention, and FIG. 11 shows the above photodetection module 400 installed in the concentrator 200A so as to receive the signals from the optical transmitter 300 shown in FIG. 10.

As shown in FIG. 10, the optical transmitter 300 is connected to a plurality of surveillance cameras, and transmits the video signals input by the surveillance cameras to the photodetection module 400 installed in the concentrator 200 by using an optical transmission method. Also, control information on the optical transmitter 300 is received through a digital data communication method using an optical transmission method, and the optical transmitter 300 is controlled according to control data.

The photodetection module 400 installed in the concentrator 200A receives video signals that are transmitted by using the optical transmission method from the optical transmitter 300, and transmits a control signal on the optical transmitter 300 to the corresponding optical transmitter 300.

In the case of using the optical transmission method, quality video signals can be transmitted when an establishment or a region is located at a distance that is difficult to be used for the xDSL transmission method. For example, in the case of using the ADSL transmission method, the downstream bandwidth is less than 1 Mbps when the distance to the central control center is greater than 5 km, while quality video signals can be transmitted up to a distance of about 80 km when the optical transmission method is used.

Also, the network may be formed in a point-to-point structure or a ring structure when the remote surveillance video transmitter is formed by using the optical transmission method. In the case of the point-to-point structure, receiving and transmission are processed in a single line, in a like manner of the exemplary embodiment. In the case of the ring structure, one of the optical transmitter and the photodetection module is used for receiving, and the other thereof is used for the corresponding transmission. In the case of using the ring structure, the cost of installing and managing a remote monitoring device is reduced since a plurality of optical transmitters and photodetection modules can be connected to a single optical fiber.

FIG. 10 shows a detailed configuration of the optical transmitter 300.

As shown, the optical transmitter 300 includes a switch module 310, a communication processor 320, an Ethernet-physical layer interface 330, and an electrical/optical converter 340. The switch module 310 is connected to a plurality of surveillance cameras, receives video signals therefrom, and outputs the video signals to the channels corresponding to the number of surveillance cameras. The communication processor 320 controls other units of the optical transmitter 300 according to control information provided by the photodetection module 400. The Ethernet-physical layer interface 330 converts the signal output by the switch module 320 into a physical layer signal or converts the control information transmitted by the photodetection module 400 into a signal available for the internal part of the optical transmitter 300, and outputs the signal to the switch module 310. The electrical/optical converter 340 converts the electrical video signal output by the Ethernet-physical layer interface 330 into an optical signal and transmits the optical signal to the photodetector 400, or converts the optical signal of the control information transmitted by the photodetector 400 into an electrical signal.

In a like manner of the previous exemplary embodiment, the communication processor 320 of the optical transmitter 300 according to the present exemplary embodiment may include a communication CPU, an FPGA, a flash memory, and an SDRAM.

FIG. 11 shows a detailed configuration of the photodetection module 400.

As shown, the photodetection module 400 includes an electrical/optical converter 410, an Ethernet-physical layer interface 420, a switch module 430, and a communication processor 450. The electrical/optical converter 410 converts an optical signal transmitted by the optical transmitter 300 into an electrical signal or converts an electrical control signal for controlling the optical transmitter 300 into an optical signal, and transmits the resultant signal. The Ethernet-physical layer interface 420 converts an electrical video signal of a physical layer output by the electrical/optical converter 410 into an Ethernet-based signal or converts a control signal for controlling the optical transmitter 300 into a physical layer signal. The switch module 430 receives video signals from a plurality of Ethernet-physical layer interfaces 420 and outputs the video signals to a backplane of the concentrator or outputs a control signal for the optical transmitter 300 transmitted by the communication processor 440 to the corresponding Ethernet-physical layer interface 420. The communication processor 450 processes a control signal for the optical transmitter 300 input by the main processing module 230 of the concentrator 200 and outputs the processed control signal.

In a like manner of the optical transmitter 300, the communication processor 450 includes a communication CPU, an FPGA, a flash memory, and an SDRAM. In this instance, the communication CPU monitors link speed and state information of the optical transmitter 300, and controls to reset the optical transmitter 300 and manage the MAC according to control information input by the main processing module 230.

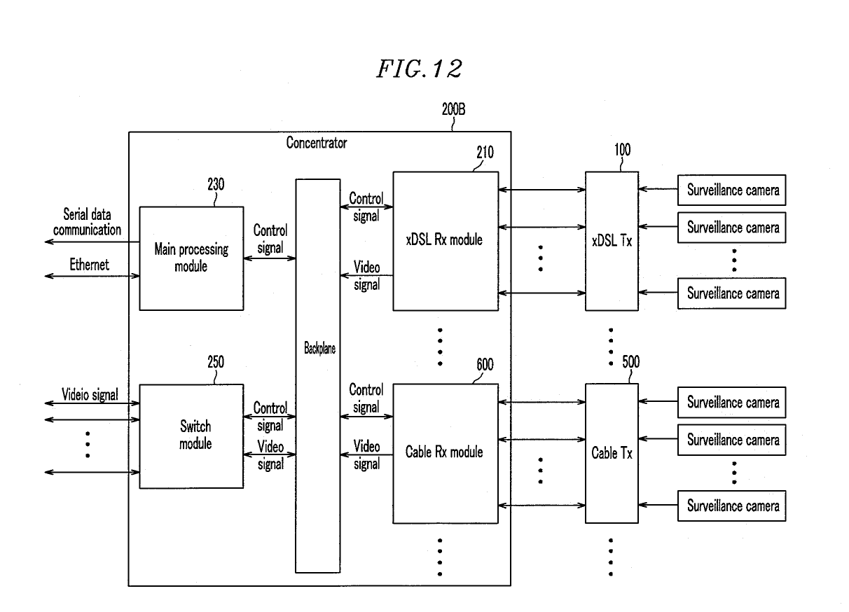

FIG. 12 shows a video transmitter for remote monitoring according to another exemplary embodiment of the present invention. The remote surveillance video transmitter shown in FIG. 12 uses a cable transmission method in addition to the xDSL transmission method. Therefore, the present embodiment has the same configuration as that of the previous embodiment, except for further including a cable transmitter 500 for modulating and transmitting video signals of the surveillance cameras and a cable receiving module 600. The same modules or units will have the same reference numerals as those of the previous exemplary embodiment.

As shown in FIG. 12, the video transmitter for remote monitoring includes a cable transmitter 500 and a cable receiving module 600 so as to use the cable transmission method. The cable transmitter 500 is connected to a plurality of surveillance cameras in a like manner of the previous exemplary embodiment. It is desirable to connect the cable transmitter 500 and the surveillance cameras according to the Ethernet method. The cable receiving module 600 for receiving signals from the cable transmitter 500 is installed in the concentrator 200B. It is desirable to connect the cable receiving module 400 to the backplane of the concentrator according to the same transmission method as that of the xDSL receiving module 210 of the previous exemplary embodiment. Accordingly, it is easy to install a receiving module into a slot of a main board without identifying the slot types so as to extend the facility.

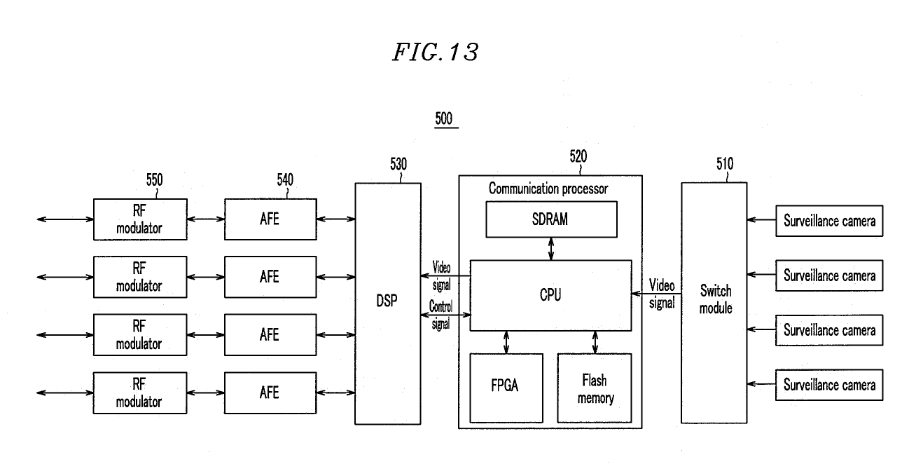

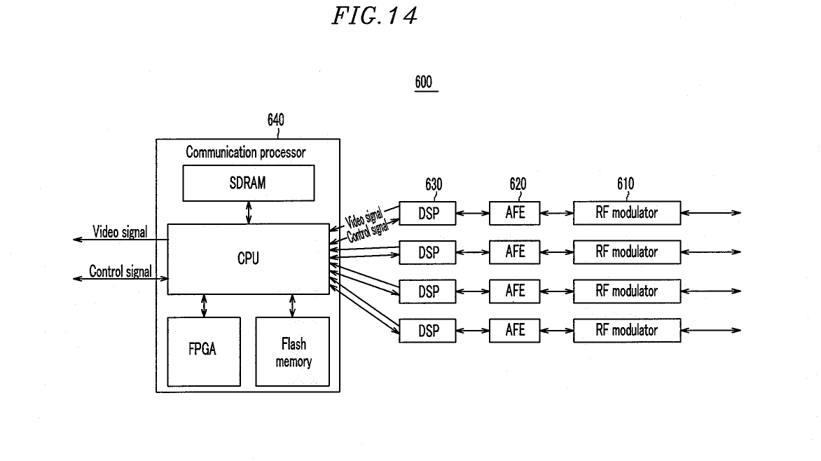

FIG. 13 shows the above cable transmitter 500 according to the present exemplary embodiment of the present invention, and FIG. 14 shows the above cable receiving module 600 being installed in the concentrator 200B and receiving signals from the cable transmitter 500 shown in FIG. 13.

As shown in FIG. 13, the cable transmitter 500 is connected to a plurality of surveillance cameras and transmits video signals input by the surveillance cameras to the cable receiving module 600 installed in the concentrator 200B through the coaxial cable. Also, the cable transmitter 500 receives control information on the cable transmitter 500, and controls the cable transmitter 500 according to control data.

The cable receiving module 600 installed in the concentrator 200B receives video signals from the cable transmitter 500 through the optical transmission method, and transmits a control signal on the cable transmitter 500 to the cable transmitter 500.

FIG. 13 shows a detailed configuration of the cable transmitter 500.

As shown, the cable transmitter 500 includes a switch module 510, a communication processor 520, a DSP 530, a plurality of AFEs 540, and a plurality of RF modulators 550. The switch module 510 is connected to a plurality of surveillance cameras, receives video signals therefrom, and outputs the video signals to the channels corresponding to the number of the surveillance cameras. The communication processor 520 controls operations of other units of the cable transmitter 500 according to control information provided by the cable receiving module 600, and the DSP 530 performs a framing process to eliminate errors. The AFEs 540 convert digital data provided by the DSP 530 into analog signals or perform A/D conversion on the received analog signals, and transmit digital signals to the DSP 530, and the RF modulators 550 modulate the signals output by the AFEs 540.

In a like manner of the previous exemplary embodiment, the communication processor 520 of the cable transmitter 500 according to the present exemplary embodiment may include a communication CPU, an FPGA, a flash memory, and an SDRAM.

FIG. 14 shows a detailed configuration of the cable receiving module 600.

As shown, the cable receiving module 600 includes a communication processor 640, a plurality of DSPs 630 connected to the communication processor 640, a plurality of AFEs 620, and a plurality of RF modulators 630. The RF modulators 630 demodulate received signals, and the AFEs 620 perform an A/D conversion on the signals output by the RF modulators 630 and transmit digital signals to the DSPs 610. The DSPs 630 receive video signal from the AFEs 620 and perform a framing process to eliminate errors. The communication processor 640 controls the DSPs 630, the AFEs 620, and the line drivers 610, and processes the received signals according to the internal transmission rule of the concentrator 200. The video signals output by the communication processor 610 are transmitted to the switch module 250 through the backplane of the concentrator 200B. The communication processor 640 may include a network processor, an FPGA, a flash memory, and an SDRAM.

Also, the xDSL receiving module 600 receives a control signal on the xDSL receiving module 600 from the main processing module 230 to perform a corresponding operation, or receives a control signal on the cable transmitter 500 and transmits the control signal to the corresponding cable transmitter 500.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the present invention, the transmitter or the receiver receives the video signals output by a plurality of surveillance cameras through a parallel method without passing through a multiplexer, and has a function of transmitting the video signals without compressing them, and hence, the data processing speed is not delayed and quality images are provided when a single communication processor processes the image data input by a plurality of surveillance cameras.

Also, since the present invention allows transmission of video signals of the surveillance cameras by using the optical transmission method as well as the xDSL transmission method, it is possible to provide more appropriate security and surveillance on a distant establishment or region to be monitored compared to the method of using only the xDSL transmission method.

1. A video transmitter for remote monitoring for transmitting a video signal output by a surveillance camera installed in an establishment to be monitored to a central control center that is distant from the establishment, the video transmitter comprising:
at least one transmitter, installed in the establishment to be monitored and connected to a predetermined number of the surveillance cameras, for receiving video signals of the surveillance cameras in parallel, and transmitting the video signals of the surveillance cameras to the central control center at a predetermined upstream data rate, the transmitter being controlled by control data transmitted by the central control center; and
a concentrator, installed in the central control center, including at least two receiving modules for concentrating the video signals transmitted by the respective transmitters, transmitting the concentrated video signals to the central control center's manager, receiving control data for the transmitters from the central control center's manager, and transmitting the control data to the transmitters at a downstream data rate that is equal to or less than the upstream data rate.

2. The video transmitter of claim 1, wherein
the concentrator further comprises a main processing module for outputting a signal for controlling one of the concentrator according to the manager's operation and the transmitter, and a switch module for outputting video signals to outside of the concentrator.

3. The video transmitter of claim 1, wherein
the transmitter transmits data through a telephone line as a medium by using the xDSL transmission method.

4. The video transmitter of claim 3, wherein the transmitter comprises:
a switch module for receiving a video signal from the surveillance camera;
a communication processor for processing the video signals input by the switch module according to the asynchronous transfer mode (ATM) and outputting resultant signals;
a digital signal processor for performing a framing process to eliminate the error of the signal output by the communication processor;
an analog front end for performing D/A conversion on the signals input by the digital signal processor; and
a line driver for eliminating noise of transmitted and received signals and compensating signal distortion.

5. The video transmitter of claim 4, wherein
the transmitter comprises a digital signal processor for providing the same number of output channels as that of the connected surveillance cameras, and video signals corresponding to the respective surveillance cameras are output to the output channels.

6. The video transmitter of claim 1, wherein
the transmitter transmits data by using an optical transmission method.

7. The video transmitter of claim 6, wherein the transmitter comprises:
a switch module for receiving video signals from the surveillance camera and outputting the video signals;
a communication processor for controlling the second transmitter according to a control signal input by the concentrator;
an Ethernet-physical layer interface for converting the signals output by the switch module into physical layer signals; and
an optical/electrical converter, connected to the Ethernet-physical layer interface, for converting electrical signals to optical signals or converting optical signals to electrical signals.

8. The video transmitter of claim 1, wherein
the transmitter transmits data by using a coaxial cable as a medium.

9. The video transmitter of claim 8, wherein the transmitter comprises:
a switch module for receiving video signals from a surveillance camera and outputting the video signals;
a communication processor for controlling the transmitter according to a control signal input by the concentrator, processing the video signals input by the switch module according to a transmission rule, and outputting resultant signals;
a digital signal processor for performing a framing process to eliminate errors of signals output by the communication processor;
an analog front end for performing D/A conversion on the signals input by the digital signal processor; and
an RF modulator for eliminating noise of transmitted and received signals and compensating signal distortion.

10. The video transmitter of claim 3, wherein
the concentrator comprises a receiving module that corresponds to the transmitter for transmitting data by using the xDSL transmission method using a telephone line as a medium.

11. The video transmitter of claim 10, wherein the receiving module comprises:
a communication processor;
a plurality of digital signal processors respectively connected to the communication processor;
a plurality of analog front ends connected to one of the digital signal processors; and
a plurality of line drivers respectively connected to one of the analog front ends, wherein
the communication processor and the respective digital signal processors are connected through the UTOPIA method or the Ethernet method.

12. The video transmitter of claim 6, wherein
the concentrator comprises a receiving module that corresponds to the transmitter for transmitting data by using the optical transmission method.

13. The video transmitter of claim 12, wherein the receiving module comprises:
at least one optical/electrical converter for converting electrical signals into optical signals or converting optical signals into electrical signals;
a plurality of Ethernet-physical interfaces, connected to the optical/electrical converter, for converting physical layer signals into Ethernet-based signals;
a switch module for receiving signals from the Ethernet-physical layer interfaces and outputting to a backplane of the concentrator; and
a communication processor for controlling the optical/electrical converter, the Ethernet-physical interfaces, and the switch module.

14. The video transmitter of claim 8, wherein
the concentrator comprises a receiving module that corresponds to the transmitter for transmitting data through a coaxial cable as a medium.

15. The video transmitter of claim 14, wherein the receiving module comprises:
a communication processor;
a plurality of digital signal processors respectively connected to the communication processor;
a plurality of analog front ends respectively connected to one of the digital signal processors; and
a plurality of RF modulators respectively connected to one of the analog front ends, wherein
the communication processor and the respective digital signal processors are connected through the UTOPIA method or the Ethernet method.

16. The video transmitter of any one of claims 11, 13, and 15, wherein
the communication processor of the receiving module has no floating point operation function.

17. The video transmitter of claim 12, wherein
the transmitter transmitting data using the optical transmission method and the receiving module are connected through a point-to-point structure or a ring structure.

18. The video transmitter of claim 1, wherein the concentrator comprises:
a first receiving module for receiving data by using the xDSL transmission method through a telephone line as a medium;
a second receiving module for receiving data by using the optical transmission method; and
a third receiving module for receiving data through a coaxial cable as a medium, wherein
the first, second, and third receiving modules are connected to a backplane of the concentrator through the same internal transmission method.

19. The video transmitter of claim 1, wherein
the surveillance camera and the transmitter are connected through the Ethernet method.

20. The video transmitter of claim 1, wherein
the concentrator has a serial data port through which a signal on the state of the concentrator is output.

21. A remote security monitoring device for a remote central control center to monitor an establishment to be monitored, comprising:
a plurality of surveillance cameras installed at predetermined positions in the establishment to be monitored;
at least one transmitter, installed in the establishment to be monitored and connected to a predetermined number of the surveillance cameras, for receiving video signals of the respective surveillance cameras in a parallel manner, transmitting the video signals of the surveillance cameras to a central control center at a predetermined upstream data rate, and starting an operation controlled by control data provided by the central control center;
a concentrator, installed in the central control center, including at least two receiving modules for concentrating the video signals provided by the respective transmitters, transmitting the video signals to the central control center's manager, receiving control data on the transmitter from the central control center's manager, and transmitting the control data to the transmitter at a downstream data rate that is equal to or less than the upstream data rate;
an image processor for processing the video signals output by the concentrator; and
a display for displaying the images processed by the image processor.
